(19) United States
(12) Patent Application Publication
(10) Pub. No.: US 2012/0020077 A1
(43) Pub. Date: Jan. 26, 2012

(54) LED LIGHTING DEVICE

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/037,405

(22) Filed: Mar. 1, 2011

(30) Foreign Application Priority Data
Jul. 22, 2010 (CN) 201010234156.8

(51) Int. Cl. F21V 13/12; F21V 13/02

(52) U.S. Cl. 362/235

(57) ABSTRACT

An LED lighting device includes an encapsulation, a number of LED light sources and a light guiding member. The light guiding member is arranged inside the encapsulation, and includes two opposite curve surfaces, at least one of which defines a number of accentuated portions. One end of the light guiding member defines a light incident surface opposing the LED light sources. After entering the light guiding member from the light incident surface, the light beams from the LED light sources are reflected between opposite surfaces of the light guiding member. The light beams reaching the accentuated portions are diffused and exit the light guiding member, and finally being transmitted outside through the encapsulation.

### BACKGROUND

1. Technical Field

The present disclosure relates to lighting devices and, particularly, to a fluorescent lamp type LED lighting device with a good radiation angle.

2. Description of Related Art

With the advantages of long service life, low pollution, power conservation, and other benefits, light-emitting diodes (LEDs) are now being widely used in lighting devices. An LED is a point light source with a small radiation angle and strong directionality. To maximize illuminated surface area, a plurality of light-emitting diodes is often distributed in rows on the LED lighting device. However, compared to the almost 360° radiation angle of many fluorescent lamps, the radiation angle of a commonly used LED fluorescent lamp is only about 100° to 140°. Furthermore, high brightness LEDs cause light spots on the lighting surface of the LED lighting device. In order to reduce or eliminate the light spots and achieve a uniform lighting surface, an extra light diffusion film is needed, which may absorb part of the light from the light-emitting diodes, such that the brightness of light illumination of the LED lighting device is reduced.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of an LED lighting device according to a first embodiment.

FIG. 2 is a cross-sectional view cut along line II-II of the LED lighting device of FIG. 1.

FIG. 3 is a lighting schematic view of the LED lighting device of FIG. 2.

FIG. 4 is a cross-sectional view of a non-omnidirectional LED lighting device according to a second embodiment.

FIG. 5 is a cross-sectional view of a non-omnidirectional LED lighting device according to a third embodiment.

FIG. 6 is a cross-sectional view of a wide-angled LED lighting device according to a forth embodiment.

FIG. 7 is a cross-sectional view of a narrow-angled LED lighting device according to a fifth embodiment.

### DETAILED DESCRIPTION

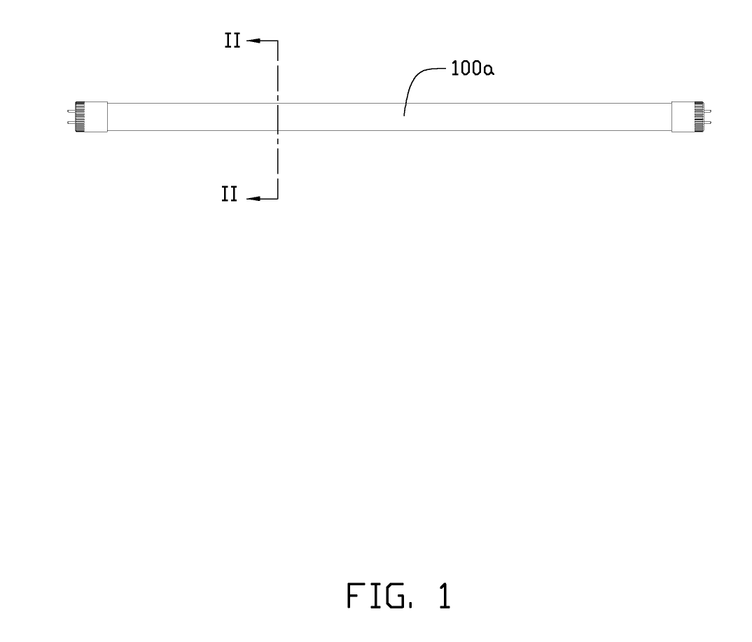

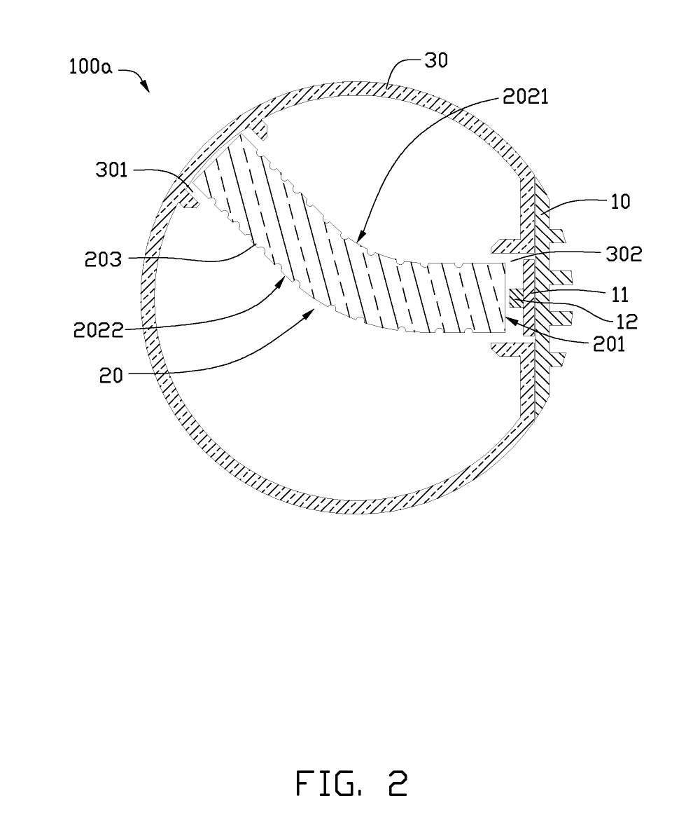

Referring to FIGS. 1 and 2, an LED lighting device 100a according to a first embodiment is illustrated. The LED lighting device 100a, which is shaped like a conventional fluorescent tube, includes a heat sink 10, a circuit board 11, a number of LED light sources 12, a light guiding member 20, and an encapsulation 30. The light guiding member 20 is arranged inside and is detachably connected to the encapsulation 30. In the embodiment, the internal lateral surface of the encapsulation 30 defines a first groove 301 and a second groove 302 opposite to each other. Two opposite ends of the light guiding member 20 are respectively placed in the first groove 301 and the second groove 302.

The circuit board 11 and the encapsulation 30 are detachably connected to the heat sink 10, with the circuit board 11 opposing the second groove 302. The LED light sources 12 are distributed in a row on the circuit board 11. The heat generated by the LED light sources 12 can be transferred to the ambient air through the heat sink 10.

The light guiding member 20 is made of optical material, and the end of the light guiding member 20 in the second groove 302 includes a light incident surface 201 opposing the LED light sources 12. The light guiding member 20 includes two opposite reflective surfaces. In the embodiment, the cross-section of the light guiding member 20, cut along a line perpendicular to the lengthwise direction of the LED lighting device 100a, is arc-shaped, and the two surfaces of the light guiding member 20 are respectively formed to be a first curved surface 2021 and a second curved surface 2022.

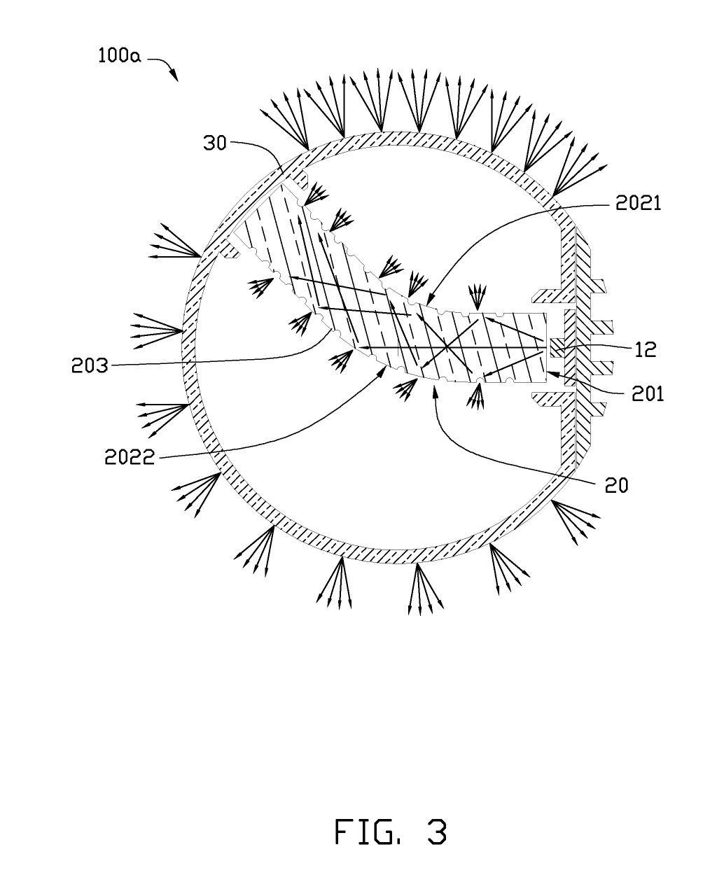

In order to adjust the illumination positions and the illumination intensity on the surfaces of the light guiding member 20, a number of accentuated portions 203, such as protuberances and/or recesses are defined in at least one surface of the light guiding member 20. Referring to FIG. 3, after entering the light guiding member 20 from the light incident surface 201, the light beams from the LED light sources 12 are reflected between opposite surfaces of the light guiding member 20. The light reaching the accentuated portions 203 is diffused and exits the light guiding member 20, finally being transmitted outside through the encapsulation 30.

The encapsulation 30 is made of optical material. In the embodiment, the encapsulation 30 is made of diffusion material including a plurality of methyl methacrylate particles. The methyl methacrylate particles function as a plurality of diffusion particles. In other embodiments, the encapsulation 30 defines a number of accentuated portions, such as elongated parallel protrusions, at its surfaces, thus, the light beams exiting from the encapsulation 30 are further diffused, to achieve a uniform and soft effect on the outside surface of the encapsulation 30.

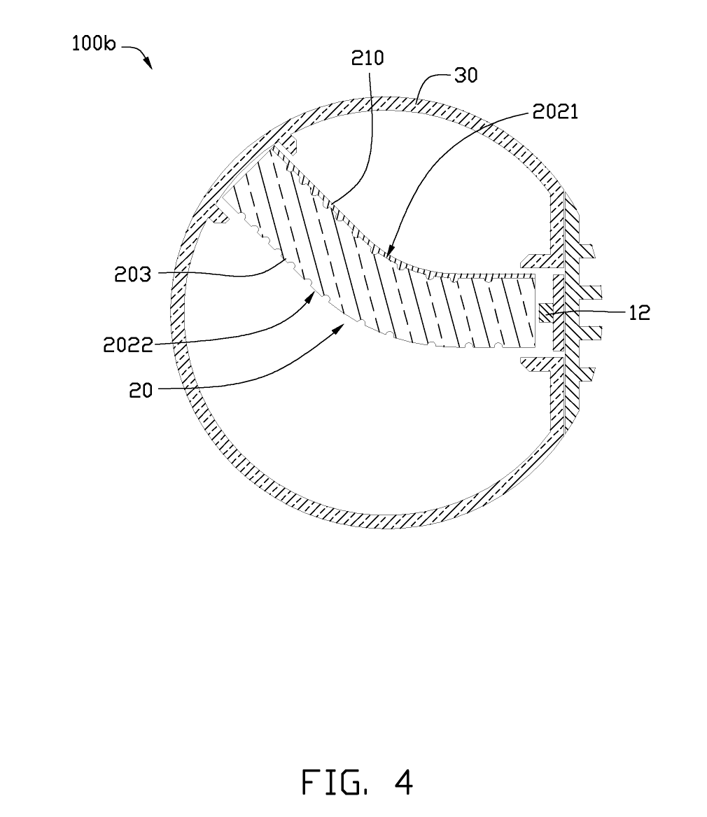

In other embodiments, a reflective film can be applied to one surface of the light guiding member 20, to prevent light beams from going out of the surface, which allows the light beams from the light sources 12 to be directed substantially in a desired direction. For example, as shown in FIG. 4, a non-omnidirectional LED lighting device 100b according to a second embodiment is illustrated. The LED lighting device 100b is similar to the above-described LED lighting device 100a shown in FIG. 2. However, a reflective film 210 is applied to the curved surface 2021 of the LED lighting device 100b. The light beams reaching the reflective film 210 are respectively reflected to the curved surfaces 2022 opposite to the reflective film 210.

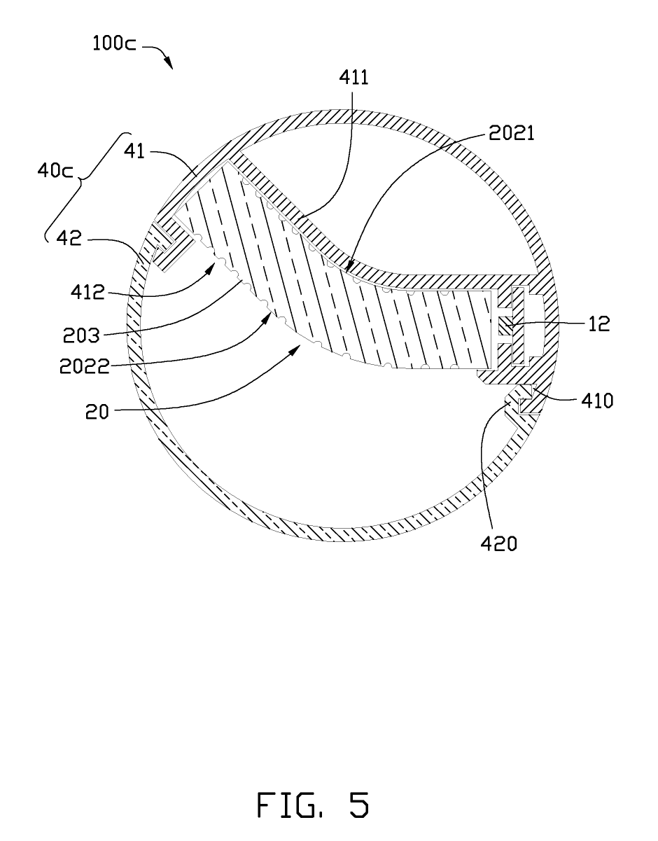

Another example of non-omnidirectional LED lighting device 100c is shown in FIG. 5. The LED lighting device 100c is similar to the above-described LED lighting device 100a shown in FIG. 2. However, the encapsulation 40c includes a reflecting member 41 and a transmitting member 42. A fastening portion 410 is defined in each edge of the reflecting member 41, and a fastening portion 420 is defined in each edge of the transmitting member 42. The fastening portion 410 engages the corresponding fastening portion 420, thereby connecting the reflecting member 41 and the transmitting member 42 together.

The reflecting member 41 includes a curve surface 411 that together with the fastening portions 410 define a groove 412 mating with the light guiding member 20. The light guiding member 20 is positioned in the groove 412, and a curve surface of the light guiding member 20, such as the first curve surface 2021, is close to the curve surface 411 of the reflecting member 41. The light beams travelling to the curve surface 411 are respectively reflected to the curve surface 2022 of the light guiding member 20 opposite to the curve surface 411. The light beams from the light sources 12 are directed to the area of the transmitting member 42 that faces the curve surface 411, while the area of the reflecting member 41 has no light beams directed thereon. In the embodiments, the reflecting member 41 is made of reflective material. In other embodiments, a reflective layer is coated on the curve surface 411.

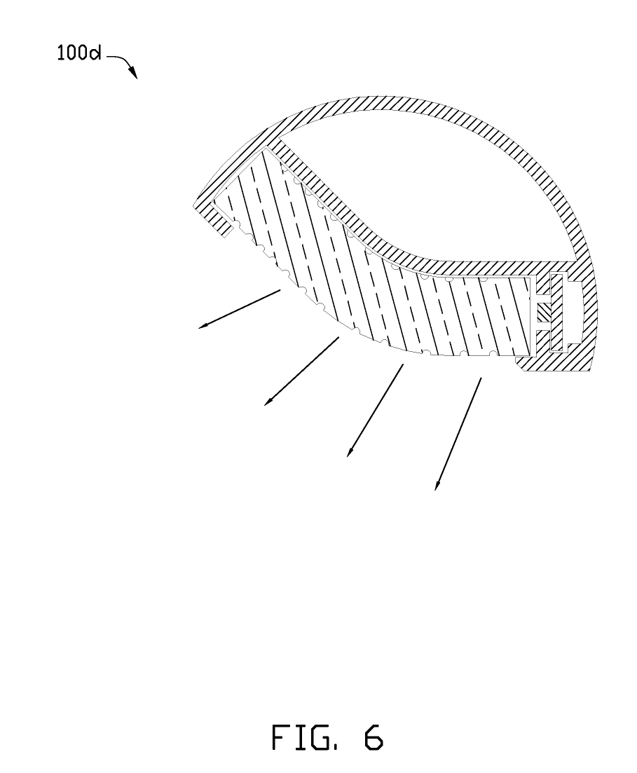

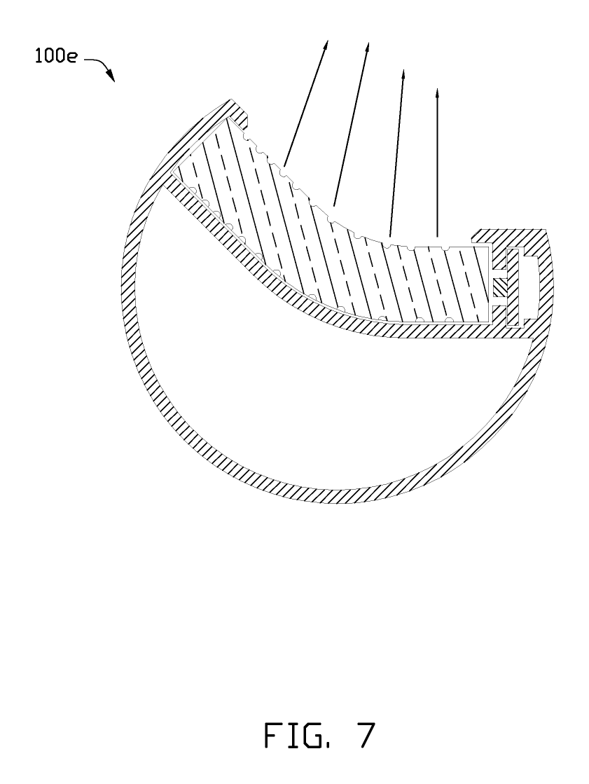

In other embodiments, the transmitting member 42 can be omitted. In such cases the light beams may go out from the curve surface of the light guiding member 20 opposite to the curve surface 411 of the reflecting member 41, an LED lighting device 100d with wide-angled surface light source can be obtained as shown in FIG. 6. In addition, an LED lighting device 100e with narrow-angled surface light source can be obtained as shown in FIG. 7.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A light emitting diode (LED) lighting device comprising:
a circuit board and an encapsulation;
a plurality of LED light sources distributed on the circuit board; and
a light guiding member arranged inside the encapsulation and comprising two opposite curve surfaces, at least one of which defines a plurality of accentuated portions, one end of the light guiding member defining a light incident surface opposing the LED light sources;
wherein after entering the light guiding member from the light incident surface, the light beams from the LED light sources are reflected between opposite surfaces of the light guiding member; the light beams reaching the accentuated portions are diffused and exit the light guiding member, and finally being transmitted outside through the encapsulation.

2. The LED lighting device of claim 1, wherein the internal lateral surface of the encapsulation defines a first groove and a second groove opposite to each other, and two opposite ends of the light guiding member are respectively placed in the first groove and the second groove.

3. The LED lighting device of claim 2, wherein the circuit board and the encapsulation are detachably connected to the heat sink, with the circuit board opposing one of the first groove and the second groove.

4. The LED lighting device of claim 1, wherein a reflective film is applied to one curve surface of the light guiding member, to prevent light beams from going out of the surface, which allows the light beams from the light sources to be directed substantially in a desired direction.

5. The LED lighting device of claim 1, wherein the encapsulation is made of optical material.

6. The LED lighting device of claim 1, wherein the encapsulation is made of diffusion material including a plurality of methyl methacrylate particles.

7. The LED lighting device of claim 1, wherein the encapsulation comprises a reflecting member, each edge of which defines a first fastening portion, the reflecting member defines a curve surface that together with the first fastening portion define a third groove mating with the light guiding member; the light guiding member is positioned in the third groove, and one curve surface of the light guiding member is close to the curve surface of the reflecting member.

8. The LED lighting device of claim 7, wherein the encapsulation further comprises a transmitting member, each edge of which defining a second fastening portion, wherein the first fastening portion engages the corresponding second fastening portion, thereby connecting the reflecting member and the transmitting member together.

9. The LED lighting device of claim 7, wherein the reflecting member is made of reflective material.

10. The LED lighting device of claim 7, wherein a reflective layer is coated on the curve surface of the reflecting member.
